(19) United States
(12) Patent Application Publication
(10) Pub. No.: US 2007/0061706 A1
(43) Pub. Date: Mar. 15, 2007

(54) Mapping property hierarchies to schemas

(75) Inventors: Shiraz J. Cupala, Seattle, WA (US); Andrew P. Begun, Redmond, WA (US); Raj B. Merchant, Kirkland, WA (US); Dragos Barac, Bellevue, WA (US); Hani Saliba, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/226,044

(22) Filed: Sep. 14, 2005

(51) Int. Cl. G06F 15/00

(52) U.S. Cl. 715/513; 715/523

(57) ABSTRACT

Various embodiments provide a translation mechanism in which property architectures associated with various objects are translated into a schema that maintains the semantics of the property architecture. In at least some of the embodiments, the property architectures are translated into hierarchical, standards-based schemas which enhance the environments in which associated objects can be consumed and processed.

### BACKGROUND

Software objects typically have properties associated with them. Properties describe characteristics of software objects. For example, a software object in the form of an electronic document may have properties that include the author of the document, title, date reviewed and the like. In systems that create such objects or at least understand them, the semantics of the properties and their interrelation with one another, such as inheritance relationships, is typically understood. Yet, attempting to move these objects to different environments, other than the ones in which they were created or that understand these system-defined relationships, can present challenges in order to maintain the semantics of these properties and their interrelationship with one another.

### SUMMARY

Various embodiments provide a translation mechanism in which property architectures associated with various objects are translated into a schema that maintains the semantics of the property architecture. In at least some of the embodiments, the property architectures are translated into a hierarchical, standards-based schema which enhances the environments in which associated objects can be consumed and processed.

### BRIEF DESCRIPTION OF THE DRAWINGS

FIG. 1 illustrates exemplary property domains and objects to provide context for the discussion in this document.

FIG. 2 further embellishes the FIG. 1 illustration.

FIG. 3 illustrates a system in accordance with one embodiment.

### DETAILED DESCRIPTION

Overview

Various embodiments described below provide a translation mechanism in which property architectures associated with various objects are translated into a schema that maintains the semantics of the property architecture. Thus, in some contexts, properties that are represented in a first format, such as a flat or relational database format can be translated into a second format, such as a schema that represents and preserves the semantics of properties and their interrelationships with one another.

For example, some property architectures support the notion of inheritance in which groups of properties can be defined by inheriting from other groups of properties. This inheritance aspect establishes an inherent hierarchy that can be preserved across the translation process.

In at least some of the embodiments, the property architectures are translated into a hierarchical, standards-based schema. Although any suitable schema type can be used, in the illustrated and described embodiments, the architectures are translated into XML schemas (i.e., W3C XML Extensible Markup Language format schemas). In these embodiments, the translated property architectures can be processed and consumed by systems that understand the XML schema. Hence, a collection of objects and their associated properties that are not natively understood by such systems can, in their translated formats, be processed and consumed.

Additionally, in at least some embodiments, the property architectures are translated into a hierarchical schema that describes the relationships between the various properties in a human-readable form. Hence, in embodiments in which the architectures are translated into XML schemas, the relationships between these properties can be ascertained by an individual by simply reading the XML that embodies the property architecture.

Further, in at least some embodiments, the translation process is bi-directional. Specifically, the property architecture can be translated into a schema, and the schema can be translated back to the property architecture.

Obiects, Properties, Collections of Properties and Inheritance

The translation approach described below can be employed in the context of any environment in which objects, such as software objects, have properties. Aspects of the described embodiments are particularly useful in the context of systems that utilize property architectures in which the properties are extensible and inheritable. As such environments are many and varied, it will be appreciated and understood that attempting to describe all such environments would be a difficult task. However, to provide some context for the reader to appreciate how the inventive approach can be utilized, an environment is employed in which the objects comprise documents and the associated properties comprise properties that are associated with documents. A document can reside in many forms and/or include many different types of data including, by way of example and not limitation, text files, image files, music files and the like. That is, the term document is not to be limited to cover only what might be considered as a text file in the traditional sense. Rather, a document can include many different types of electronic representations of data. It is to be appreciated and understood that objects other than documents can be employed without departing from the spirit and scope of the claimed subject matter. For example, such objects can include, by way of example and not limitation, any type of computer file, such as an image file or any other suitable type of file. More generally, objects with which the inventive principles can be employed can include any suitable type of object that can be employed in a wide variety of environments. For example, the inventive principles can be employed in connection with objects that reside in a library indexing system, inventory system and/or a wide variety of other systems that are simply too numerous to list. In those types of systems and others, the objects might take the form of a record in a database and the like.

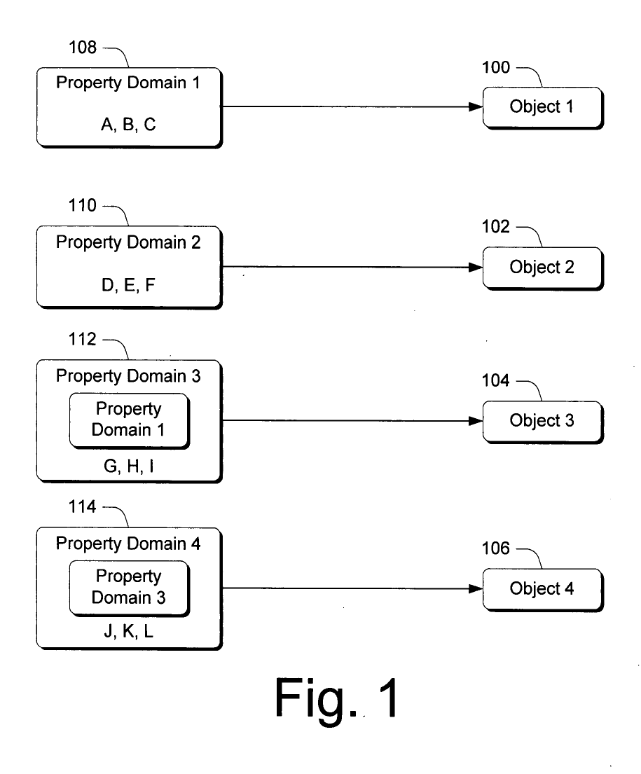

Consider FIG. 1 which illustrates a collection of objects 100, 102, 104 and 106 and a collection of so-called property domains 108, 110, 112 and 114. The objects can comprise any suitable type of objects that have associated properties. In an illustrative embodiment, objects 100-106 comprise individual documents.

The individual property domains can comprise a collection of one or more properties that can be assigned to objects 100-106. In this example, property domain 108 includes three properties, represented as A, B and C. In the document context, these individual properties might be properties such as “author”, “title” and “review date”. Property domain 110 includes three other different properties here represented as D, E and F. Again, in the document context, these three properties might be, respectively, “status”, “sub-author” and “been reviewed”.

Property domain 112 inherits properties from property domain 108, as well as adds additional properties G, H and I. Likewise, property domain 114 inherits from property domain 112 and adds additional properties J, K and L. Hence, in this example, the collection of properties associated with property domain 112 are: A, B, C, G, H and I; likewise, the collection of properties associated with property domain 114 are: A, B, C, G, H, I, J, K and L. Hence, through inheritance, a very powerful property definition tool can be utilized to create property architectures that are quite robust and useful.

Once the property architecture is created, a given property domain can be assigned to a given object. So, in this example, property domain 108 is assigned to object 100, property domain 110 is assigned to object 102, property domain 112 is assigned to object 104, and property domain 114 is assigned to object 106.

In another example, a set of global properties might be assigned to all objects in a given system via a given property domain, with individual local properties being assigned to individual objects as appropriate.

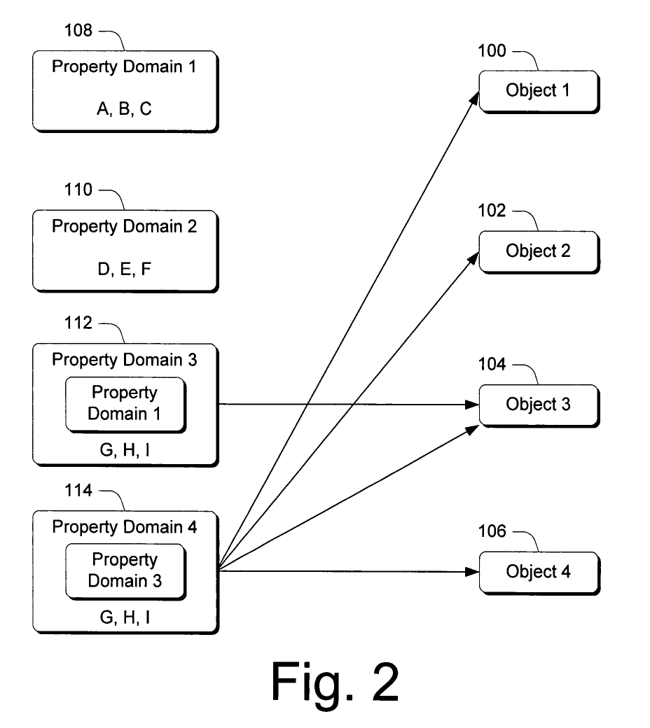

As an example, consider FIG. 2. There, the same collection of objects and property domains from FIG. 1 are shown. In this particular instance however, property domain 114 is assigned to all objects, thus constituting what can be thought of as a global property domain for all objects in the relevant system. Property domain 112, however, is assigned only to object 104, thus constituting what can be thought of as a local property domain as to object 104. It should be appreciated and understood that the above constitutes a very simple example and that there is a vast set of possibilities for property assignments to objects, as will be appreciated by the skilled artisan.

### EXEMPLARY EMBODIMENT

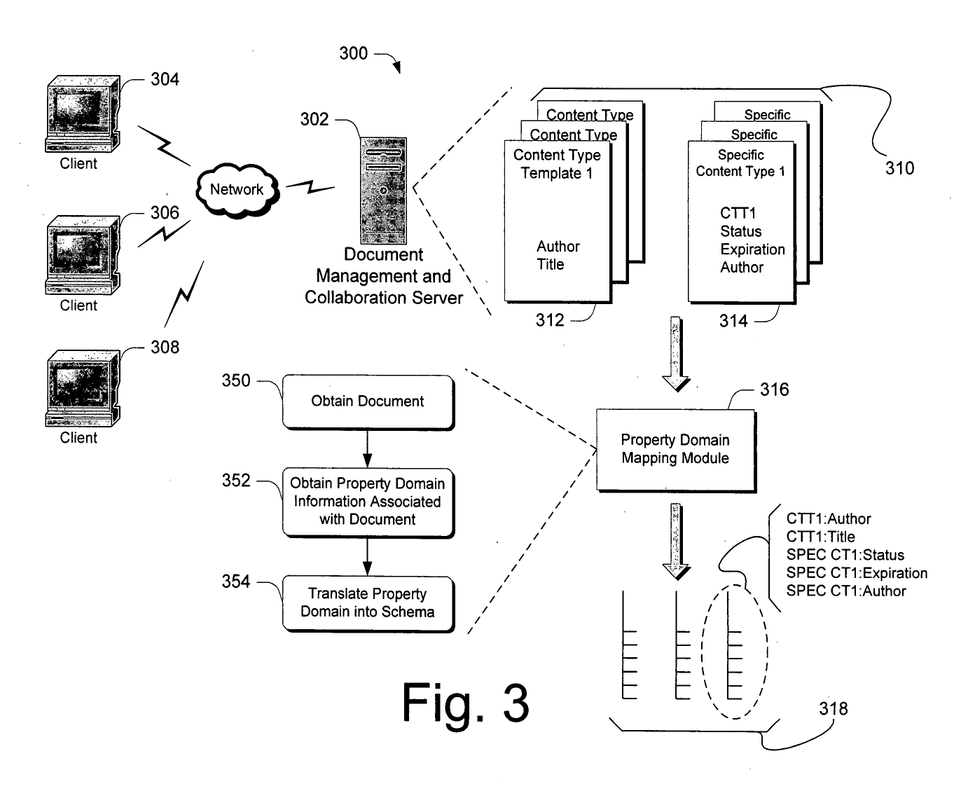

FIG. 3 illustrates an exemplary system in accordance with one embodiment generally at 300. In this example, the environment in which the inventive concepts are employed includes documents as the objects to which various properties can be assigned. This particular environment includes a document management and collaboration server 302 that is configured to maintain and manage various documents as well as the documents' properties. In this type of environment, clients such as those illustrated at 304, 306 and 308 can access and consume documents maintained by server 302. But one example of a commercially-available server that provides document management and collaboration services is Microsoft Windows SharePoint Services, as will be appreciated by the skilled artisan. It is to be appreciated and understood that this constitutes but one example of a commercially available server and is not intended to limit application of the claimed subject matter to any one particular system, or to the specific environment in which this example is given.

Server 302 maintains and manages a property architecture 310 that pertains to the various documents that the server maintains. In this particular example, the property architecture includes property domains referred to as content type templates, such as the one shown at 312, and content types, such as the one shown at 314.

A content type template provides a means to define sets of properties that can then be inherited by content types or other content type templates. This provides somewhat of a global way of assigning properties to collections of documents or other items. A content type provides a means to assign properties to one particular document. Accordingly, a content type can inherit from a content type template, as well as provide its own set of one or more properties.

As an example, consider content type template 312 and content type 314. Here, content type template 312 includes the following properties: author and title. Content type 314 inherits properties from content type template 312 as indicated by the “CTT1”, as well as includes its own properties as follows: status, expiration, and author. Notice here that both property domains include an author property, which is discussed in more detail below.

In accordance with the illustrated and described embodiment, server 302 includes a property domain mapping module 316 which is configured to translate individual property domains into a schema that maintains the semantics of the property domain. In this example, property domain mapping module 316 is implemented in the form of computer-readable instructions that reside on some type of tangible computer-readable medium. It is to be appreciated and understood, however, that module 316 may reside at a location other than on server 302.

In this example, individual translated property domains are diagrammatically illustrated at 318 as individual flat lists. Each individual flat list constitutes an individual property domain that can be associated with a particular document.

In operation, property domain mapping module 316 (and other components resident on server 302) implements a method which is illustrated just to the left of the module. Specifically, step 350 obtains a document and step 352 obtains property domain information associated with the document. These steps can be performed responsive to a request for a particular document. For example, software executing on one of clients 304, 306 or 308 may issue a request for a particular document to server 302. Having obtained the property domain information associated with a particular document, step 354 translates the property domain into a schema that preserves the semantics of the property domain. It is to be appreciated that this example is simply to illustrate but one way in which the inventive translation can take place. The translation mentioned above can take place in any suitable way and at any suitable time.

As noted above, any suitable schema definition can be used. In this particular example, the translation that takes place translates the property domains into a set of hierarchical XML-compliant schemas. The XML schemas encapsulate the property domain information and maintain its semantics. Accordingly, applications and other consumers that understand XML can access and manipulate data associated with the documents. Accordingly, such applications and other consumers need not be natively aware of the specific representation of the content types and content type templates on the server.

For example, documents that have their properties assigned by virtue of a particular content type and content type template may be represented on the server in a relational database, with their various properties residing in a number of different relational tables. Through the techniques described above and below, this relational database representation is translated into an XML-compliant format which can be consumed and understood by components that understand XML, but which are not necessarily aware at all of relational databases.

Consider now the specific example of content type 314 in FIG. 3. Assume that content type 314 has been assigned to a document that has been requested by a client. In this instance, the property domain mapping module 316 assigns a namespace for each individual content type or content type template. Hence, module 316 would assign a namespace to both content type template 312 and content type 314. Each namespace uniquely identifies its associated template or type. Having assigned each content type and template a namespace, each property associated with a content type and content type template is prefixed by its corresponding content type template or content type namespace in a flat list. In the context of this document, the term “namespace” has somewhat of a dual role. First, “namespace” carries with it its normal XML-associated meaning. More generally, however, the notion of a namespace is used to provide a sort of domain or grouping “lookup” table for tagging properties with their domain or grouping.

In the illustrated example, the document associated with content type 314 has the following elements defined by its associated XML schemas to represent its properties:

xmlns:CTT1=“ContentTypeTemplate 1”
xmlns:SpecCTT1=“SpecContentTypeTemplate 1”
<CTT1:Author/>
<CTT1:Title/>
<SpecCT1:Status/>
<SpecCT1:Expiration/>
<SpecCT1:Author/>

Notice here that the first-listed author and title are prefixed by “CTT1”. In this example, CTT1 is shorthand for “Content Type Template 1” and uniquely qualifies these properties as being associated with content type template 312. Similarly, notice that the last three listed properties are prefixed by “SpecCT1” (shorthand for “Specific Content Type 1”), thus uniquely qualifying these properties as being associated with content type 314. In this example, the two “author” properties will not collide by virtue of being prefixed by their own corresponding namespace.

In this manner, the semantics of a particular property domain can be maintained. In addition, by virtue of being translated into a standards-based XML schema, it is much easier for applications and other components to process associated documents and understand the data associated with the document.

In addition, in at least one embodiment, property domains are translated into a schema that is human readable. Accordingly, an individual can look at the schema representation and understand the relationship of the properties and any associated hierarchies that exist. Accordingly, the organization of the schema is much more readily apparent from the very beginning. In addition the human readable aspect can extend to the namespace definitions to allow an individual to look at the schema representation and understand the relationship of the properties to the relational database representation.

Further, as noted above, the translation process is bi-directional in that a property domain that is represented in an XML schema can be translated back to its original form and used to populate the properties on the server. That is, by knowing the namespace definitions in the XML schema, an application or some other component can map the XML data back to the associated content type templates and content type properties of the document on the server. Hence, in some instances, this might involve writing the data from its XML representation to its relational database representation.

Extensions

The above-described translation mechanism can be extended in a number of ways. For example, in those embodiments that translate property domains into a XML schemas, further hierarchical structure can be injected into the translation by, for example, representing each content type template or content type as a sub-tree in the XML schema. More generally, however, consider the case of an arbitrary relational database. Such databases may have significant numbers of properties. Hence, organizing these properties into hierarchical sub-trees can provide, in at least some embodiments, even more human readability and may better represent the translation. For example one may wish to take a set of name and address fields and break them into two groups (first name, last name, middle initial) and (address, city, state, zip).

### CONCLUSION

The various embodiments described above provide a translation mechanism in which property architectures associated with various objects are translated into schemas that maintain the semantics of the property architecture. In at least some of the embodiments, the property architectures are translated into one or more hierarchical, standards-based schemas which enhance the environments in which associated objects can be consumed and processed.

Although the invention has been described in language specific to structural features and/or methodological steps, it is to be understood that the invention defined in the appended claims is not necessarily limited to the specific features or steps described. Rather, the specific features and steps are disclosed as exemplary forms of implementing the claimed invention.

1. A computer-implemented method comprising:
obtaining one or more objects in a system that includes inheritable property domains from which other property domains can inherit and inheriting property domains that can inherit from the inheritable property domains, individual objects having an assigned property domain; and
translating said assigned property domain from a first format into a second different format.

2. The method of claim 1, wherein the second format maintains inheritance semantics.

3. The method of claim 1, wherein the second format comprises one or more hierarchical schemas.

4. The method of claim 1, wherein the second format is a standards-based format.

5. The method of claim 4, wherein the standards-based format comprises an XML format.

6. The method of claim 1, wherein the second format uses individual namespaces for each property domain.

7. The method of claim 6, wherein individual namespaces reside in human-readable form.

8. The method of claim 1, wherein the first format comprises a database representation format, and the second format comprises an XML format.

9. A computer-implemented method comprising:
obtaining a document in a system in which property domains that can be assigned to documents are defined by content type templates and content types, wherein content type templates define sets of properties that can then be inherited by content types and wherein said property domains are represented in said system in a non-hierarchical format;
obtaining property domain information associated with said document;
using said property domain information to translate said non-hierarchical format into an hierarchical, XML-compliant schema or schemas that preserve the semantics of the translated property domain.

10. The method of claim 9, wherein the act of using translates the non-hierarchical format into the XML compliant schema or schemas by assigning individual namespaces for each property domain.

11. The method of claim 9, wherein the act of using translates the non-hierarchical format into human-readable XML compliant schemas in which property domain semantics can be ascertained.

12. The method of claim 9, wherein said acts of obtaining and using are performed by a document management server.

13. One or more computer-readable media having computer-readable instructions thereon which, when executed, implement a method comprising:
maintaining a property architecture of individual property domains that can be assigned to documents; and
translating formats of individual property domains into XML-compliant schemas that preserve the semantics of the translated property domain.

14. The one or more computer-readable media of claim 13, wherein said act of translating is performed responsive to receiving a request for a document having an assigned property domain.

15. The one or more computer-readable media of claim 13, wherein said formats of individual property domains comprises a non-XML format.

16. The one or more computer-readable media of claim 13, wherein the act of translating comprises assigning individual namespaces for each property domain.

17. The one or more computer-readable media of claim 16, wherein individual property domains are defined by content type templates and content types, wherein content type templates define sets of properties that can be inherited by content types or other content type templates.

18. The one or more computer-readable media of claim 13, wherein the act of translating translates the formats of the individual property domains into human-readable XML compliant schemas in which property domain semantics can be ascertained.

19. A computer-implemented method comprising:
obtaining one or more objects in a system in which the one or more objects are represented in a non-hierarchical format; and
translating non-hierarchical format representations of the one or more objects into a hierarchical representation.

20. The method of claim 19, wherein said one or more objects comprise documents.

21. The method of claim 19, wherein said one or more objects do not comprise documents.

22. The method of claim 19, wherein said hierarchical representation comprises an XML representation.
